(19) United States
(12) Patent Application Publication
(10) Pub. No.: US 2001/0054182 A1
(43) Pub. Date: Dec. 20, 2001

(54) Method for the management of a decoder connected to the internet, and associated decoder

(76) Inventor: Patrick Lodola, Yerres (FR)

Correspondence Address: James E. Nilles, NILLES & NILLES, S.C., Firstar Center, Suite 2000, 777 East Wisconsin Avenue, Milwaukee, WI, 53202-5345, US

(21) Appl. No.: 09/753,999

(22) Filed: Apr. 23, 2001

(30) Foreign Application Priority Data
Jan. 4, 2000 (FR) 00 00037

(51) Int. Cl. G06F 3/00; H04N 5/445

(52) U.S. Cl. 725/50

(57) ABSTRACT

To enable a user of a television set connected to a decoder having access to a remote data source to access preferred messages for display at high speed, these messages are stored in a back-up memory of the decoder and updated at predetermined dates, or even occasionally. Thus a mini-Internet is created in the decoder, but it is a network that is regularly updated. Thus the time needed to access the message for display is reduced to the time needed to access the back-up memory in the decoder.

### BACKGROUND OF THE INVENTION

1. Field of the Invention

An object of the present invention is a method for the management of a decoder connected to the Internet. It also relates to an associated decoder. It can be applied to the field of television decoders connected firstly to a television set and, secondly, to a remote data source. Thus, the decoder receives information from the data source and sends it to the television set in an appropriate form. The aim of the invention is to enable a user to display information that has to be displayed on the screen of the television set, eliminating the waiting time related to the establishment of communication with the remote data source that has this message for display and eliminating an associated downloading time.

2. Description of the Prior Art

At present, there are two known main types of remote data sources used to download a message for display. These sources are firstly the Internet network and secondly the cable, satellite or terrestrial network. A cable network uses a wire link with a coaxial cable for example while, for the satellite or terrestrial network, the link is constituted by open space. However, these systems can be extended to any type of remote data sources used for the downloading of messages for display. As a rule, these two types of access are juxtaposed. The decoder is used to receive information from the cable, satellite or terrestrial network and a modem is used to receive information from the Internet network through the switched telephone network for example. However, the decoder can receive messages for display of the type that can be obtained from the Internet.

There are several problems with respect to this prior art. First of all, through the modem and the Internet, it is possible to obtain messages for display that can be stored but their subsequent consultation will require fresh access to the Internet network. The message for display that has been stored is not necessarily updated during this new access. Again, the decoder, when linked to a network by means of an operator, may receive Internet type messages for display from the operator. However, these messages for display are predefined and imposed on the user.

In addition, for both the above types of access, there is another problem owing to the connection time required. Indeed, between the time when the user makes a choice of a message for display or more specifically an address at which the message for display is located and the time when a set of contents of this message for display is displayed on the screen of the television set, a period of some seconds or even minutes may elapse. This access time actually depends on a bit rate allocated to a user and this allocated bit rate depends on the number of users using one and the same link simultaneously. Consequently, to put it in a simplified way, it can be said that a link actually permits a maximum bit rate and that this maximum bit rate is divided by the number of users using this link to obtain the useful bit rate per user.

### SUMMARY OF THE INVENTION

An object of the present invention is to overcome these problems by proposing a method used to manage the decoder in order to give the user faster access to messages for display. For this purpose, an internal database is created, in the decoder for example, comprising regularly updated messages for display. The user thus obtains priority access to the database rather than to the network, thus optimizing access times by reducing these times as frequently as possible to the database access time. Furthermore, a decoder is made to implement the invention.

The invention therefore relates to a method for the management of a decoder that is connected to a television set and receives a message for display, identified by an address, from a remote data source wherein:

a database is produced in a back-up memory from a collection of messages received from the remote data source;

the database is updated by means of an updating program;

from a use of the database, a statistical information table, a statistical information element comprising at least one statistical parameter is produced;

the updating program is used to manage the organization of the database on the basis of the statistical information of the table

and wherein, during a request for connection to a desired address of a message for display:

it is verified first of all that the message for display associated with this desired address is present in the database and if not, the contents of the message for display, located at the desired address, are taken from the remote data source.

The invention also relates to a television decoder comprising a back-up memory of a message for display, this message being automatically updated by an updating program.

### BRIEF DESCRIPTION OF THE DRAWING

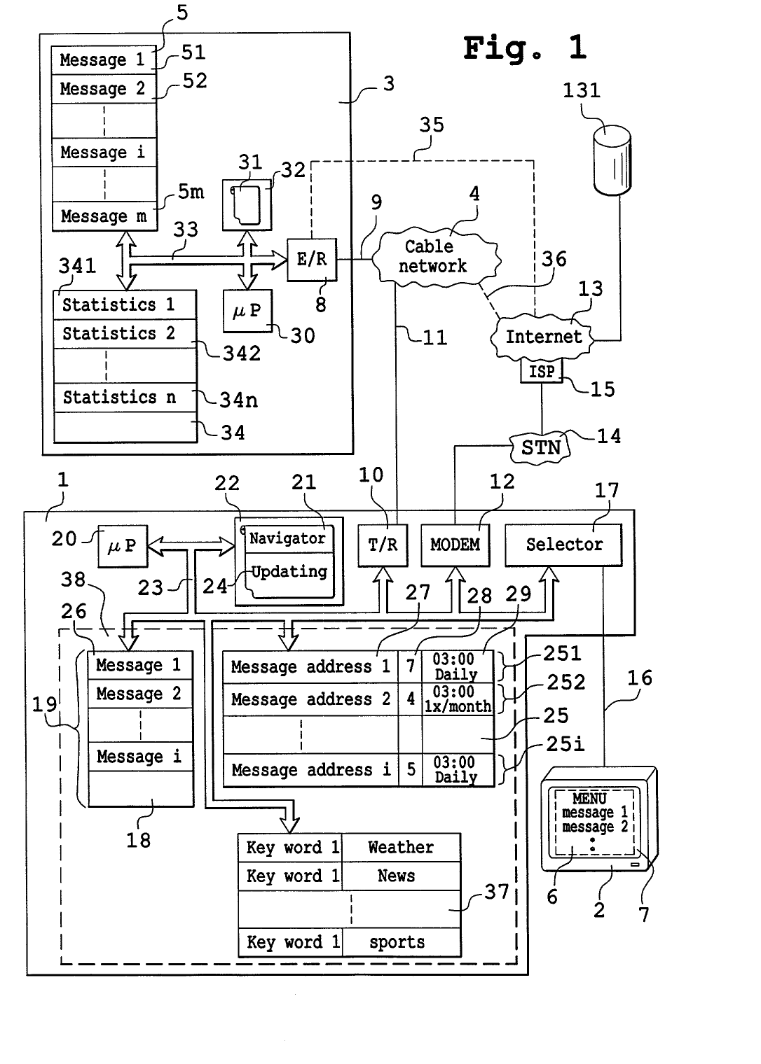

The invention will be understood more clearly from the following description and the appended FIG. 1, which is given purely by way of an indication and in no way restricts the invention. This FIG. 1 shows an exemplary architecture of a television decoder used to implement the method of the invention.

### MORE DETAILED DESCRIPTION

FIG. 1 shows an exemplary architecture used to implement the method of the invention. This example shows a television decoder 1 according to the invention connected to a television set 2. The decoder 1 receives a message for display identified by an address of a remote data source 3. This means that the decoder 1 and the source 3 are generally separated by a network 4. This network 4 in a preferred example is a videocommunications network using coaxial cables, known as a cable network, or a satellite videocommunications network.

In normal operation, the server 3 sends messages for display to the decoder 1 by means of the network 4, which sends them to the television set 2 in an appropriate form. For the television set 2, an appropriate form indicates signals having a shape that the television set 2 can use in order to display a comprehensible image. To enable this normal operation, the server 3 has a memory 5 comprising messages 5 1 to 5 m. The user of the television set 2 may select a message for display through a menu 6 on a screen 7 of the television set 2. The server 3, for this purpose, has a transmitter/receiver 8 used to access the network 4 to which it is connected by means of a link 9. The decoder 1 similarly has a transmitter/receiver 10 by which it gets connected to the network 4 through a link 11.

Furthermore, the decoder 1 of the invention comprises a modem 12 enabling a user of the television set 2 to access a remote data source connected to the network 13, for example a source 13 1. This network 13 is commonly called an Internet network and is generally accessed through a switched telephone type of network 14. The source 13 1 is generally a server such as the server 3. The network 13 is accessed by means of an access 15 controlled by an Internet Service Provider or ISP. Thus, the user of the television set 2 is connected to the decoder 1 by means of a link 16, while the decoder 1 can be connected by the link 16 using a tuner 17 as a transmitter for example.

The decoder 1 of the invention has a database back-up memory 18. This database is produced from a collection 19 of messages received from the server 3 and/or the source 13 1. More generally, messages received from the remote data source are saved in the memory 18. These received messages are for example the messages 5 1 to 5 m or again messages coming from the source 13 1. The management of the decoder 1 of the invention is provided by a microprocessor 20 controlled by a program 21 in a program memory 22 and a control, address and data bus 23. Hereinafter, the program 21 will be called a navigator 21. This navigator 21 enables a user of the television set 2 to search for a piece of information through the network 4 and/or through the network 13 and/or in preferably in the memory 18.

According to a first essential characteristic of the invention, the contents of the database are updated by means of an updating program 24 in the memory 22. This program 24 is responsible chiefly for replacing a message of the collection 19 by an updated version of this message. Furthermore, the database is used to produce a table 5 of statistical information 25 1, 25 2, 25 i. A piece of information 25 1 to 25 i comprises at least one statistical parameter. A statistical parameter associated with a message for display is used to estimate the interest of the user in this message for display. This table 25 may be controlled by the program 24 or by another statistical program of the memory 22.

Consequently, the program 24 is used to manage the organization of the database using statistical information from the table 25. The term “management of the organization of the database” is understood to mean the control of the capacity of an available memory zone of the memory 18 that can receive new messages. The term is also understood to mean the updating of the messages thus stored in the memory 18. More generally, the term is understood to mean any operation to act upon a message stored in the memory 18 in order to make its contents relevant to a user, a relevant set of contents being the most recent contents. Thus, when a user requests a connection to a desired address of a message for display, the navigator 21 first of all ascertains that the message for display associated with this desired address is present in the database, namely that it forms part of the collection 19. If not, the navigator 21 is responsible for making a connection with a remote data source. Following this connection, the contents of the message for display, located at the desired address, may be picked up for display and saving in the memory 18. If the message for display is in the memory 18, the time taken to access this message is reduced to the access time to the memory 18 whereas, if the message has to be downloaded from the data source, then the access time depends on the time needed to set up the connection with this remote data source, for example the server 3, as well as the downloading time which may be very long, especially for accessing the source 13 1.

In a preferred variant of the invention, the navigator 21 and/or the updating program 24 are used for the automatic management of the updating of the data in the memory 18. For this purpose, the program 24 for example informs the program 21 that an updating is necessary. In this case, the program 21 accesses the remote data source regularly in order to pick up an updated set of contents, associated with a message for display, of the database. The previous remote data source is naturally the one with the latest version of the message for display being considered. For example, the memory 18 comprises a message 26 that has to be updated. It will be recalled that a message for display is identified by an address. Thus, the navigator 21 makes a connection with this address in order to pick up the contents thereof and substitute them for the message 26. In this example, the address of the message 26 corresponds to the location of the message 5 1 of the server 3. In this case, the message 5 1 will replace the message 26.

A piece of information 25 1 to 25 i has several fields including a field to memorize the address of a corresponding message in the memory 18 for example, for the information 25 1, a field 27. In a simple exemplary embodiment of the invention, a statistical piece of information comprises three fields. Thus, the information 25 1 for example comprises a first field corresponding to the field 27, a second field 28 used, for its part, to store a statistical parameter and a field 29 used, for its part, to program a date on which the updating has to be done.

In this exemplary operation, a statistical parameter is placed in a piece of statistical information, for example the information 25 1. This statistical parameter pertains to a frequency of use of the message for display, an address of which is stored in the field 27, this statistical parameter being stored in the field 28.

In an exemplary application, the address of the field 27 identifies a message for display pertaining to a daily weather bulletin. Thus a piece of information giving the program 24 an indication of when the updating has to be done is place in the field 29. In the example, the updating has to be done every day at 3:00 AM. Consequently, the field 29 will have a value providing an indication to the program 24 that the message associated with this address contained in the field 27 must be re-updated every day at 3:00 AM for example. Thus every morning, when the user of the television watches the weather bulletin, the navigator 21 will look for the message pertaining to this bulletin in the memory 18 and will therefore be able respond to the user's request almost immediately except for the time taken to access the memory 18.

However, it may happen that it is no longer possible to save the messages for display in the memory 18. In this case, the program 24 eliminates a message for display that is deemed to be the one least used. To make a judgment on frequency of the display and hence of the use of a message for display, the program 24 uses the contents of the field such as the field 28 and eliminates the message for which a value in the field indicates that the associated message is the least used. Furthermore, the decoder 1 is generally associated with a server of an operator, for example the server 3. Thus, the server 3, comprising a microprocessor 30 controlled by a program 31 in a program memory 32 and a control, address and data bus 33, may send the decoder 1 predefined and imposed messages. These messages are not always timely. In this case, and in a preferred example of the invention, the navigator 21 sends the server 3 a set of contents of the table 25. The server 3 receiving the contents of the table 25 saves it in a back-up memory 34 at a location 34 1 reserved for a user of the decoder 1, other locations 32 2 to 32 n being reserved for other users who can also access the server 3. These information elements that the server 3 imposes on the decoder 1 may be information elements coming from the source 13 1 connected to the network 13 to which the server 3 is connected, either directly by a link 35 or by the network 4 which itself is connected to the network 13 by a link 36. Thus, with the contents of the table 25, it is easy to estimate the profile of the user. On the basis of this profile, the program 31 of the server 3 can make a choice, for each user, of the type of message to be sent to him. Consequently, a user thereafter receives information for display from the operator according to the profile prepared from the table 25 which has been sent by the server 3. This information is sent through the link 11 automatically and at high speed.

Furthermore, a statistical parameter may, as we have seen, be an identifier of the message for display. This identifier is an information element such as an address or a key word used to characterize the message for display. Indeed most usually, in messages sent from the network 13, each message for display has a word or a set of words to characterize this message for display. In the example of the weather bulletin, it is possible to have key words that are weather-related words and/or news. Thus, it may be planned to store these key words in the decoder 1 in a table 37 or else to store them in additional fields of the table 25.

In the invention, the memory 18 is placed in the decoder 1. However, it is quite possible to consider placing the memory 18 in the television set 2. Furthermore, the memory 18, the table 25 as well as the table 37 may be either three physically separated units of the memories or units belonging to one and the same back-up memory 38. In one example, this memory 38 is what is called a mass memory or again a hard disk, i.e. in a simple example, it will be a rotating disk on which information is stored in magnetic form.

In one variant of the invention, the program 24 updates the database when the use of the decoder 1 allows it, namely when a user does not use the decoder 1 in accessing the network 13 for example. The invention thus prevents the overloading the microprocessor 20 and therefore the slowing down of the operation of the decoder 1.

What is claimed is:

1. A method for the management of a decoder that is connected to a television set and receives a message for display, identified by an address, from a remote data source wherein:
a database is stored in a back-up memory of the decoder from a collection of messages received from the remote data source;
the database is updated by means of an updating program;
from a use of the database, a statistical information table, a statistical information element comprising at least one statistical parameter is stored in the decoder;

2. A method according to claim 1, wherein
during a request for connection to a desired address of a message for display, it is first verified that the message for display, associated with this desired address, is present in the database and, if so, it is taken therefrom,
If not, a set of contents of the message for display, located at the desired address, is taken from the remote data source.

3. A method according to one of the claims 1 to 2, wherein
the remote data source is accessed by means of a cable network and/or a satellite network and/or an Internet network.

4. A method according to claim 1 to 3, wherein
the remote data source is accessed regularly in order to take a set of updated contents associated with a message for display of the database.

5. A method according to one of the claims 1 to 4, wherein
the statistical parameter used is an identifier of the message for display, the identifier being a piece of information such as an address, or a word, by which the message for display can be characterized.

6. A method according to one of the claims 1 to 5, wherein
a statistical parameter pertaining to a frequency of use of the message for display is placed in a piece of statistical information, and wherein
when it is no longer possible to save a message for display in the back-up memory, a message for display present in the database is eliminated, starting from the least used message.

7. A method according to one of the claims 1 to 6, wherein
the decoder is associated with a server of an operator,
a set of contents pertaining to the table of statistical information is sent to the server,
a piece of information for display, in concordance with a profile set up on the basis of the table, is received from the server.

8. A method according to one of the claims 1 to 7, wherein
the back-up memory is placed in the decoder.

9. A method according to one of the claims 1 to wherein
the database is updated when a use of the decoder allows it.
